(19) United States
(12) Patent Application Publication
(10) Pub. No.: US 2014/0338250 A1
(43) Pub. Date: Nov. 20, 2014

(54) DECOY SYSTEM AND METHOD

(71) Applicant: Dario Leventini, Acampo, CA (US)

(72) Inventor: Dario Leventini, Acampo, CA (US)

(21) Appl. No.: 13/898,183

(22) Filed: May 20, 2013

(51) Int. Cl. A01M 31/06

(52) U.S. Cl. CPC A01M 31/06
USPC 43/3

(57) ABSTRACT

A system and method for providing floating decoys is described. The system includes a mechanism for moving tethered decoys in a motion that mimics the natural movement of floating waterfowl. The mechanism includes a motor that moves one end of the tether in a circular, or approximately circular motion along the surface of the water. The decoys then move back and forth on the surface of the water.

### BACKGROUND OF THE INVENTION

1. Field of the Invention

The present invention generally relates to the field of small game hunting, and more specifically to a decoy system and method for use in bird hunting, particularly waterfowl hunting.

2. Discussion of the Background

Decoy systems are used by hunters to lure water fowl. Such systems use floating decoys, such as wooden models of ducks, that are constrained or forced to move in a natural motion. The decoys are tethered to the ground (such as the bottom or shore of a lake, for example). In some systems, the motion of the water is sufficient to cause the decoys to move. In other systems, the tether is pulled or moved to cause the decoy to move on the surface of the water.

In general, prior art decoy systems are complex and/or do not provide a natural, random motion of floating waterfowl.

Thus there is a need in the art for a decoy system that is easy to use and that simulates realistic, random floating decoy motions.

### BRIEF SUMMARY OF THE INVENTION

The present invention overcomes the disadvantages of prior art decoy systems by moving the decoys back and forth over a small distance on the water.

Certain embodiments provide a decoy system for moving decoys on the surface of a body of water. The system includes a line having a first end and a second end; one or more floating decoys attached to said line; and a mechanism that moves said first end in a direction that is at least partially perpendicular to the line at said first line end. When said mechanism moves said first line end, at least one of said one or more decoys move in a direction at least partially perpendicular to the line near said at least one decoy.

Certain other embodiments provide a decoy system for moving decoys on the surface of a body of water. The decoy system includes a first stake assembly for placing in the ground; a second stake assembly for placing in the ground; a line extending from a first end attached to said first stake assembly and a second end attached to said second stake assembly; a mechanism that moves said first line end in a direction that is at least partially perpendicular to the line at said first line end; and one or more decoys attached to said line. When said first stake assembly and said second stake assembly are placed in the ground, said one or more decoys float on the surface of the water. When said mechanism moves said first line end, at least one of said one or more decoys moves in a direction at least partially perpendicular to the line near said at least one decoy.

Certain embodiments provide a method of moving decoys on the surface of a body of water. The method includes placing one or more tethered floating decoys on the water, where the tether includes a first end and a second end; and moving said first end in a direction that is at least partially perpendicular to said line at said first end. At least one of said one or more decoys move in a direction at least partially perpendicular to the line near said at least one decoy.

These features together with the various ancillary provisions and features which will become apparent to those skilled in the art from the following detailed description, are attained by the decoy system of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a side view of a first embodiment decoy system;

FIG. 2 is a side view of one embodiment of a first stake assembly that can be used with the decoy system of FIG. 1;

FIGS. 3A-3D are bottom views of the movement mechanism of FIG. 1 in four sequential positions, where: FIG. 3A is the movement mechanism in a first position, FIG. 3B is the movement mechanism in a second position, FIG. 3C is the movement mechanism in a third position, and FIG. 3D is the movement mechanism in a fourth position; and

FIGS. 4A-4D are top views of the embodiment of FIG. 1 in four sequential positions, corresponding to FIGS. 3A-3D, where: FIG. 4A is the decoy system with the movement mechanism in a first position, FIG. 4B is the decoy system with the movement mechanism in a second position, FIG. 4C is the decoy system with the movement mechanism in a third position, and FIG. 4D is the decoy system with the movement mechanism in a fourth position.

Reference symbols are used in the Figures to indicate certain components, aspects or features shown therein, with reference symbols common to more than one Figure indicating like components, aspects or features shown therein.

### DETAILED DESCRIPTION OF THE INVENTION

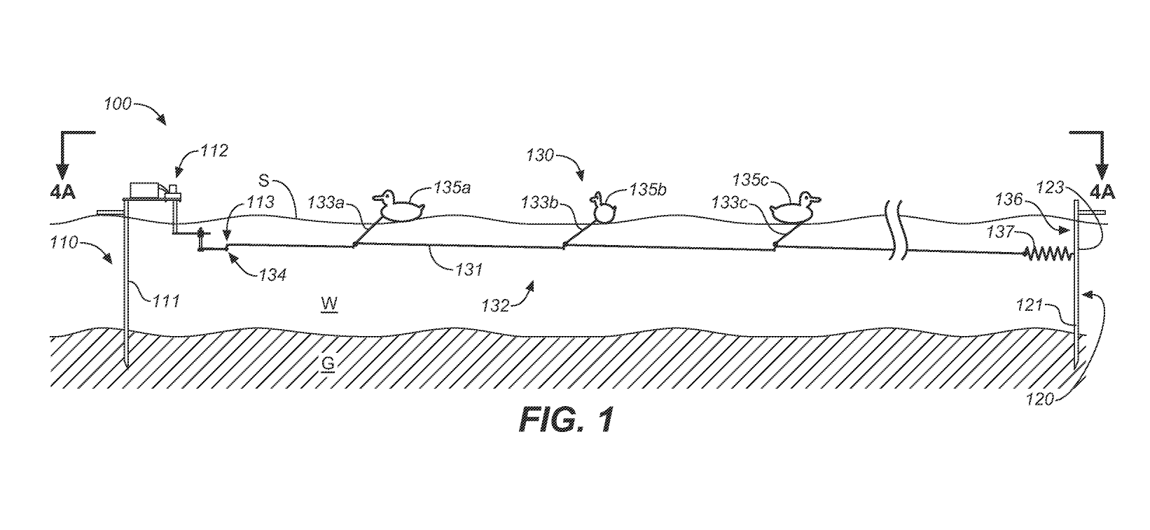

FIG. 1 is a side view of a first embodiment decoy system 100 that is illustrated, for example, on a body of water W, such as a lake or pond, having a surface S and a bottom G. System 100 includes a decoy assembly 130 attached to a first stake assembly 110 and a second stake assembly 120. Decoy assembly 130 includes one or more floating decoys 135 and is secured to a lake bottom G by stake assemblies 110 and 120. More specifically, stake assembly 110 includes a stake 111 for inserting into lake bottom G and a movement mechanism 112 having a line attachment 113, and second stake assembly 120 includes a stake 121 for inserting into the lake bottom and a line attachment 123. While stakes 111 and 121 are illustrated in FIG. 1 as being inserted into the bottom of water W, one or both of stakes may be inserted into the shore of water W. Optionally, one or more of ends 110 or 120 may be secured to other objects, such as to a dock.

Decoy assembly 130 includes a line 132 with a first end 134, shown attached to first stake line attachment 113, and a second end 136, shown attached to second stake line attachment 123 In one embodiment, line 132 is at least partially elastic. In another embodiment, line 132 includes a combination of elastic and inelastic portions, where FIG. 1 shows one embodiment of line 132 as including: an inelastic portion 131, which may be a cord formed from a synthetic material, such as a monofilament line, and which includes first end 134, and an elastic portion, such as a rubber band, or spring 137, which includes second end 136.

Decoy assembly 130 includes one or more floating decoys 135, illustrated, for example and without limitation, as decoys 135a, 135b, and 135c. Each decoy is attached to line 132 by a tether 133. Decoys 135a, 135b, and 135c are shown, for example as being attached to line 132 by tethers 133a, 133b, and 133c, respectively.

In another embodiment, system 100 includes adjustable elements. Thus, for example, the height of line attachments 134 and/or 123 are adjustable by providing discrete attachment points on stake 121 and/or 111 provided, or are provided on a movable collar to be continuously adjustable. In another embodiment, discrete or continuously adjustable radial attachment is provided for line attachment 134, such as along the length of arm 209.

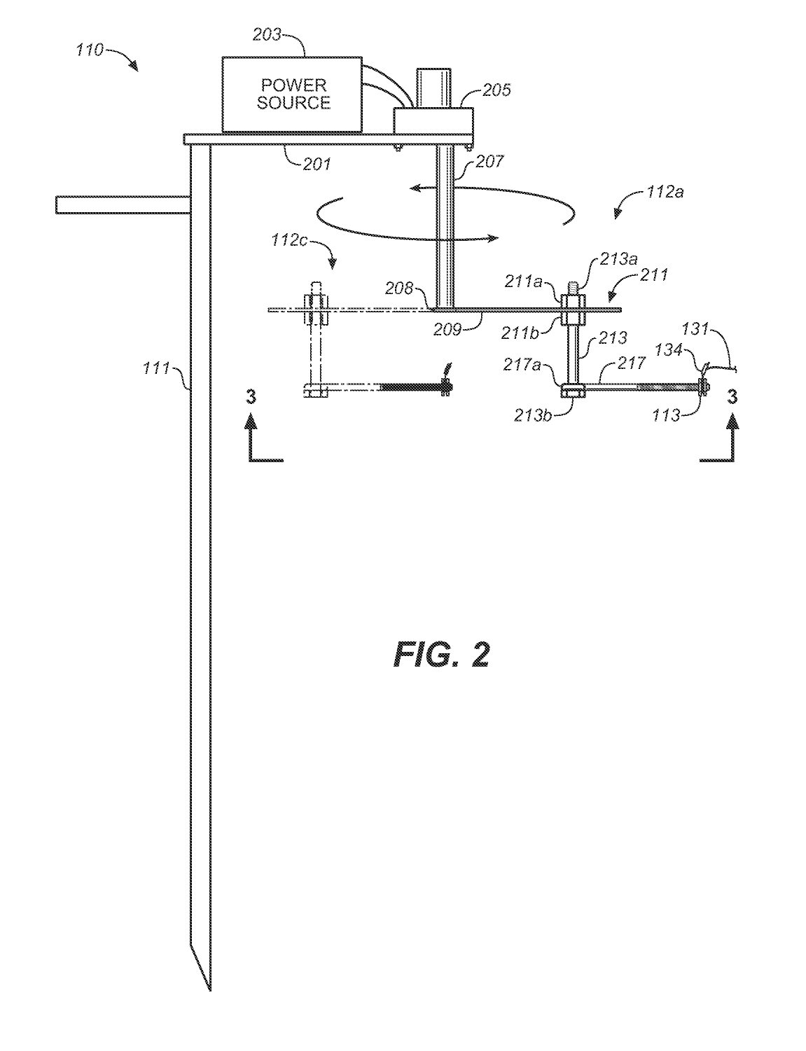

FIG. 2 is a side view of one embodiment of first stake assembly 110 that can be used with the decoy system of FIG. 1. Specifically, first stake assembly 110 includes an element 201 attached to sake 111 that supports movement mechanism 112. Mechanism 112 includes a power source 201 and motor 205 that are both attached to element 201, a shaft 207 that protrudes from motor 205, an arm 209 that is rigidly connected to shaft 207 at connection 208, a shaft 213 that is rotatably connected to arm 209 at connection 211, and an element 217 that is rotatably attached to shaft 213 at connection 215 and which includes line attachment 113.

In one embodiment, shaft 213 is a lag bolt that includes a threaded end 213a and a head 213b. Shaft 213 passes through a hole (not shown) in arm 209. Connection 211 includes a pair of nuts 211a and 211b on either of the hole of arm 209. In another embodiment, element 217 is, for example, an eye bolt having an eye 217a. Connection 215 is formed by eye 217a loosely supported by head 213b.

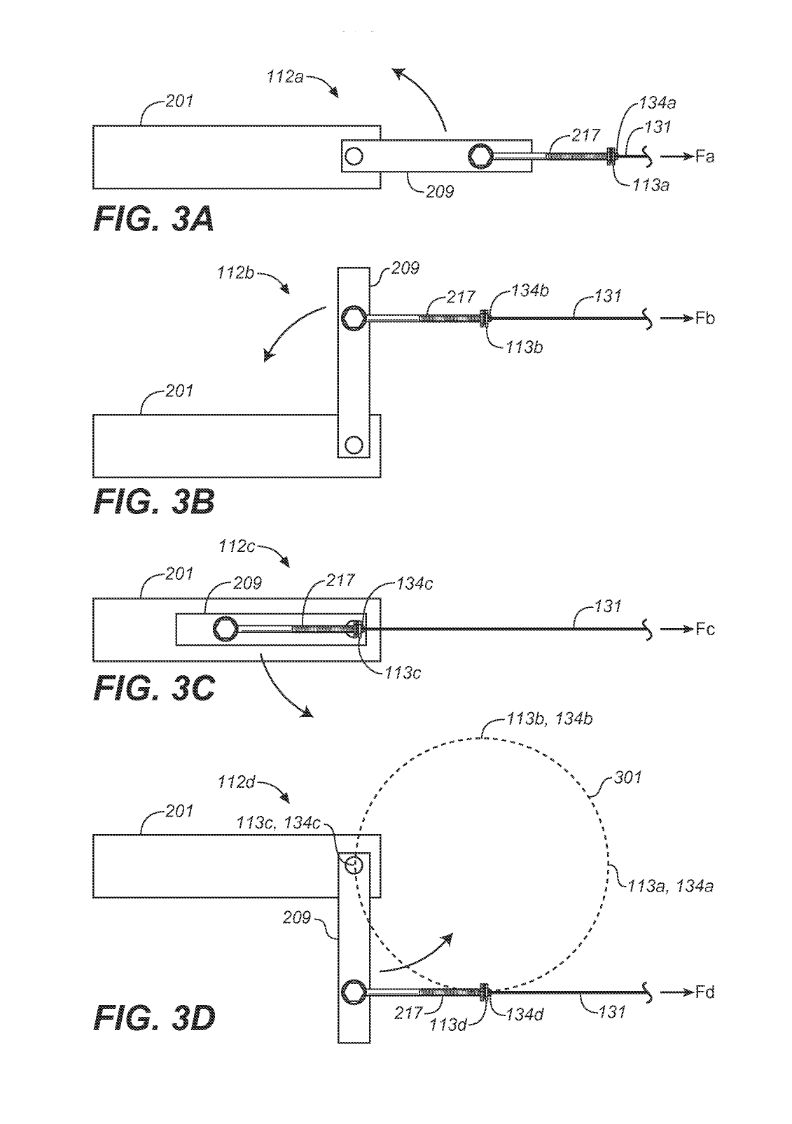

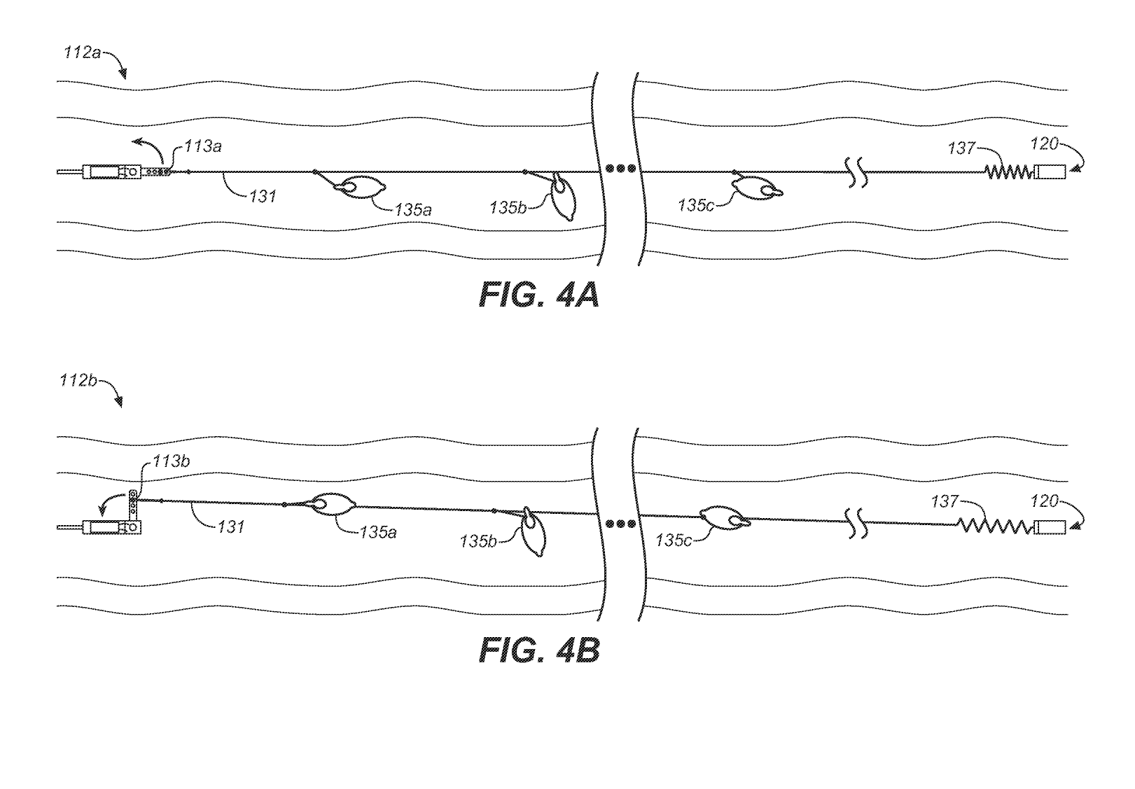

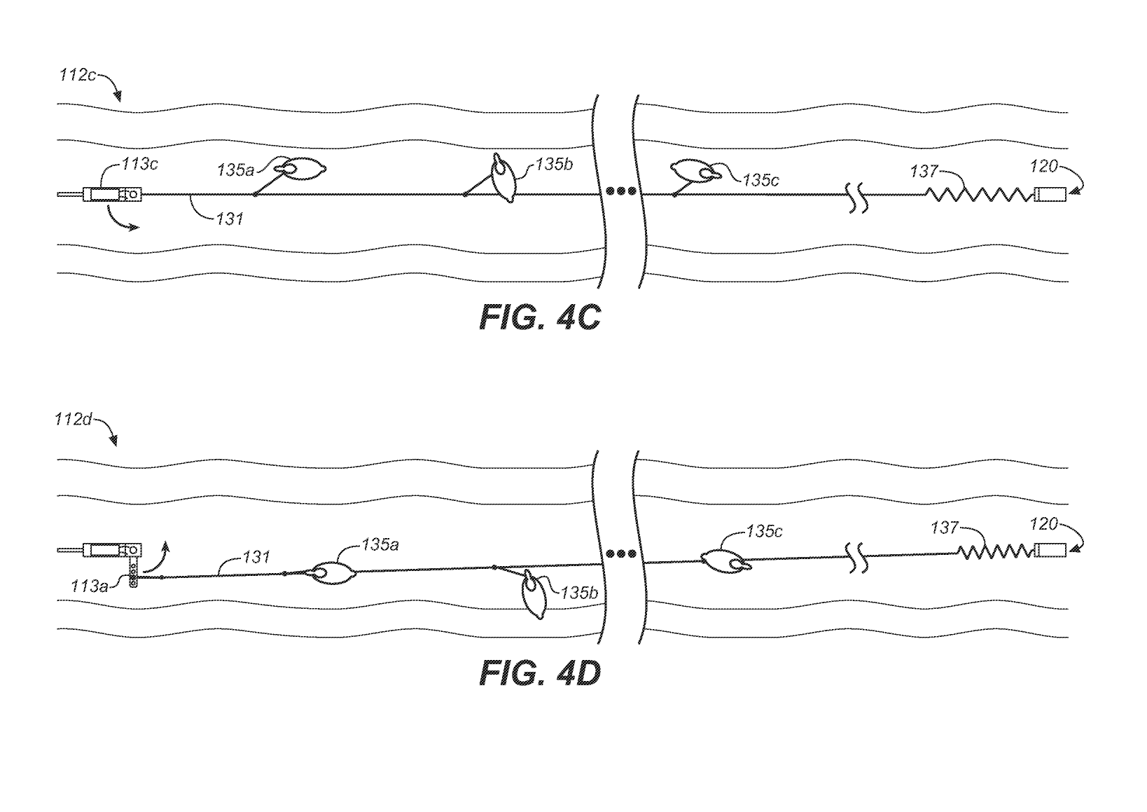

As described subsequently, power that is applied to motor 205 from power source 203 causes shaft 207 and arm 209 to rotate about the axis of shaft 207. Thus as shaft 207 rotates, shaft 213 executes circular motion about the axis of shaft 207, allowing line attachment 113 to execute a circular motion or some other more complicated motion depending on forces applied by line 132 on mechanism 112. This motion causes mechanism 112 to assume, for example, four sequential positions, shown in FIGS. 3 and 4, labeled as positions 112a, 112b, 112c, and 112d. FIG. 2 shows configuration 112a in solid lines and configuration 112c in dashed lines.

FIGS. 3A-3D are bottom views of the movement mechanism of FIG. 1 in four sequential positions, and FIGS. 4A-4D are top views corresponding to FIGS. 3A-3D, where: FIGS. 3A and 4A show the decoy system in a first position 112a and having a first line attachment position 113a, FIGS. 3B and 4B show the decoy system in a second position 112b and having a second line attachment position 113b, FIGS. 3C and 4C show the decoy system in a third position 112c and having a third line attachment position 113c, and FIGS. 3D and 4D show the decoy system in a fourth position 112d and having a fourth line attachment position 113d.

As shown in FIGS. 3A-3D and 4A-4D, mechanism 112 rotates arm 209 in a circular motion, where the rotation between sequential FIGS. 3A/4A, 3B/4B, 3C/4C, and 3D/4D is 90 degrees. Line 132 is secured at end 134 to mechanism 112 and by end 136 to stake assembly 123. The elasticity of line 132 results in a force on line attachment 113, shown as force Fa on first line attachment 113a position in FIG. 3A, force Fb on second line attachment position 113b in FIG. 3B, force Fc on third line attachment position 113c in FIG. 3C, and force Fd on fourth line attachment 113d in FIG. 3D. The forces on the line attachment cause the line to remain taut as mechanism 112 rotates, causing line end 134 to move perpendicular to the length of the line. In certain embodiments, the such as when the length of line 132 is very long, the force on mechanism 112 from line 132 (such as forces Fa, Fb, Fc, and Fd) are substantially parallel, as shown in FIG. 3, and line end 134 moves in an approximately circular motion, as shown in the dashed circle in FIG. 3D. If the forces are not parallel, as caused by a short line 132, the resulting motion of line end 134 may be an oval or some other non-circular closed path.

FIGS. 3A-3D also show that, as end 134 moves, decoys 135 move back and forth. As a result of the rotation of motor 205, each decoy 135 executes a nearly circular motion.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

We claim:

1. A decoy system for moving decoys on the surface of a body of water, said decoy system comprising:
a first stake assembly for placing in the ground;
a second stake assembly for placing in the ground;
a line extending from a first end attached to said first stake assembly and a second end attached to said second stake assembly;
a mechanism that moves said first line end in a direction that is at least partially perpendicular to the line at said first line end; and
one or more decoys attached to said line,
such that, when said first stake assembly and said second stake assembly are placed in the ground, said one or more decoys float on the surface of the water, and
such that, when said mechanism moves said first line end, at least one of said one or more decoys moves in a direction at least partially perpendicular to the line near said at least one decoy.

2. The decoy system of claim 1, where said mechanism moves said first line end in a circular motion.

3. The decoy system of claim 1, where said line includes an elastic portion.

4. The decoy system of claim 3, where said elastic portion includes a spring.

5. A decoy system for moving decoys on the surface of a body of water, said decoy system comprising:
a line having a first end and a second end;
one or more floating decoys attached to said line; and
a mechanism that moves said first end in a direction that is at least partially perpendicular to the line at said first line end,
such that, when said mechanism moves said first line end, at least one of said one or more decoys move in a direction at least partially perpendicular to the line near said at least one decoy.

6. The decoy system of claim 5, further comprising:
a first stake assembly for placing in the ground; and
a second stake assembly for placing in the ground,
where said first end is attached to said first stake assembly and where said second end is attached to said second stake assembly.

7. The decoy system of claim 5, where said mechanism moves said first line end in a circular motion.

8. The decoy system of claim 5, where said line includes an elastic portion.

9. The decoy system of claim 8, where said elastic portion includes a spring.

10. A method of moving decoys on the surface of a body of water, said method comprising
placing one or more tethered floating decoys on the water, where the tether includes a first end and a second end; and
moving said first end in a direction that is at least partially perpendicular to said line at said first end,
such that at least one of said one or more decoys move in a direction at least partially perpendicular to the line near said at least one decoy.

11. The method of claim 10,
where said placing includes placing, in the ground, a first stake assembly attached to said first end, and a second stake assembly attached to said second end.

12. The method of claim 10,
where said moving moves said first line end in a circular motion.

13. The method of claim 10, where said line includes an elastic portion.

14. The method of claim 13, where said elastic portion includes a spring.
